(19) United States
(12) Patent Application Publication
(10) Pub. No.: US 2026/0091713 A1
(43) Pub. Date: Apr. 2, 2026

(54) CONTINUOUS MANUAL RECLINER SYSTEM

(71) Applicant: Camaco, LLC, Farmington Hills, MI (US)

(72) Inventors: Jeff Carroll, West Bloomfield, MI (US); Sanjay Vakil, Troy, MI (US); Mohammad Fazli, Farmington Hiills, MI (US)

(73) Assignee: Camaco, LLC, Farmington Hills, MI (US)

(21) Appl. No.: 18/903,805

(22) Filed: Oct. 1, 2024

(51) Int. Cl. B60N 2/225

(52) U.S. Cl. CPC B60N 2/2255

(57) ABSTRACT

A recliner system includes a plate, a spring, an inner support, and an outer support. The plate has a protrusion. The protrusion defines a bore. The coil body is positioned along and around an exterior surface of the protrusion. The inner support is at least partially positioned within the bore. The inner support includes protrusions extending outside of the bore and along an exterior of the spring. Each of the protrusions is configured to selectively engage with a respective leg of the spring. The outer housing is disposed around the protrusions of the inner housing and the spring. The outer housing defines cavities with a notch positioned therebetween. The cavities extend around the legs. The notch is configured to selectively engage with the legs of the spring. The inner support and the outer housing engage with the plate on the same side of the plate.

### BACKGROUND

A vehicle may include a cabin that has a seat assembly that accommodates and supports an occupant. The seat assembly includes an upper frame, a lower frame, and a reclining system that pivotably couples the upper frame to the lower frame.

### SUMMARY

One embodiment of the present disclosure relates to a manual recliner system for a vehicle seat. The manual recliner system includes a plate, a spring, an inner support, and an outer support. The plate has a protrusion extending therefrom. The protrusion defines a bore. The spring includes a coil body and a pair of legs. The coil body is positioned along and around an exterior surface of the protrusion of the plate. The inner support is at least partially positioned within the bore. The inner support includes a pair of protrusions extending outside of the bore and along an exterior of the coil body. Each of the pair of protrusions is configured to selectively engage with a respective one of the pair of legs of the spring. The outer housing is disposed around the protrusions of the inner support and the spring. The outer housing defines a pair of cavities with a notch positioned therebetween. The pair of cavities extends around the pair of legs. The notch is configured to selectively engage with the pair of legs of the spring. The inner support and the outer housing engage with the plate on the same side of the plate.

Another embodiment relates to a seat. The seat includes a frame assembly and a recliner assembly. The frame assembly includes a seat bottom and a seat back. The recliner assembly is configured to facilitate pivoting of the seat back relative to the seat bottom. The recliner assembly includes a connecting shaft extending between the seat bottom and the seat back, and a manual reclining system. The manual reclining system includes a plate, a spring, an inner support, and an outer housing. The plate has a protrusion extending therefrom. The protrusion defines a bore. The spring including a coil body and a pair of legs. The coil body is positioned along and around an exterior surface of the protrusion of the plate. The inner support at is least partially positioned within the bore. The inner support includes a pair of protrusions extending outside of the bore and along an exterior of the coil body. Each of the pair of protrusions is configured to selectively engage with a respective one of the pair of legs of the spring. The outer housing is disposed around the protrusion of the inner support and the spring. The outer housing defines a pair of cavities with a notch positioned therebetween. The pair of cavities extend around the pair of legs. The notch is configured to selectively engage with the pair of legs of the spring.

Still another embodiment of the present disclosure relates to a manual recliner system for a vehicle seat. The manual recliner system includes a plate, a spring, an inner support, and an outer support. The plate has a protrusion extending therefrom. The protrusion defines a bore. The spring includes a coil body and a pair of legs. The coil body is positioned along and around an exterior surface of the protrusion of the plate. The inner support includes (i) a central protrusion at least partially positioned within the bore and (ii) a pair of protrusions radially spaced from the central protrusion and extending outside of the bore and along an exterior of the coil body. Each of the pair of protrusions is configured to selectively engage with a respective one of the pair of legs of the spring. The outer housing is disposed around the pair of protrusions of the inner support and the spring. The outer housing defines a pair of cavities with a notch positioned therebetween. The pair of cavities extend around the pair of legs. The notch is configured to selectively engage with the pair of legs of the spring.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle, according to an exemplary embodiment.

FIG. 2 is a perspective view of a cabin of the vehicle of FIG. 1 including a seat, according to an exemplary embodiment.

FIG. 3 is a perspective view of a frame assembly of the seat of FIG. 2 including a seat frame assembly and a manual recliner system, according to an exemplary embodiment.

FIG. 4 is a perspective view of the manual recliner system of FIG. 3, according to an exemplary embodiment.

FIG. 5 is another perspective view of the manual recliner system of FIG. 3, according to an exemplary embodiment.

FIG. 6 is an exploded view of the manual recliner system of FIG. 3, including an inner support, an outer housing, a leaf-shaped plate, a coiled spring, a ring, and an end cap, according to an exemplary embodiment.

FIG. 7 is a cross-sectional side view of the manual recliner system of FIGS. 4 and 5, according to an exemplary embodiment.

FIG. 8 is a cross-sectional view of the manual recliner system of FIGS. 4 and 5, according to an exemplary embodiment.

FIGS. 9 and 10 are various perspective views of the inner support of FIG. 6, according to an exemplary embodiment.

FIGS. 11 and 12 are various perspective views of the outer housing of FIG. 6, according to an exemplary embodiment.

FIGS. 13 and 14 are various perspective views of the leaf-shaped plate of FIG. 6, according to an exemplary embodiment.

FIG. 15 is a perspective view of the coiled spring of FIG. 6, according to an exemplary embodiment.

FIGS. 16 and 17 are various perspective views of the ring of FIG. 6, according to an exemplary embodiment.

FIGS. 18 and 19 are various perspective views of the end cap of FIG. 6, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Vehicle and Passenger Cabin

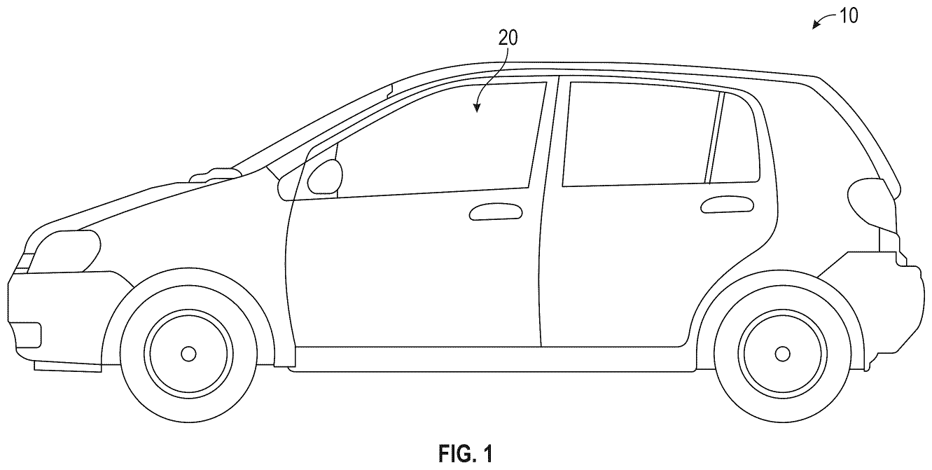

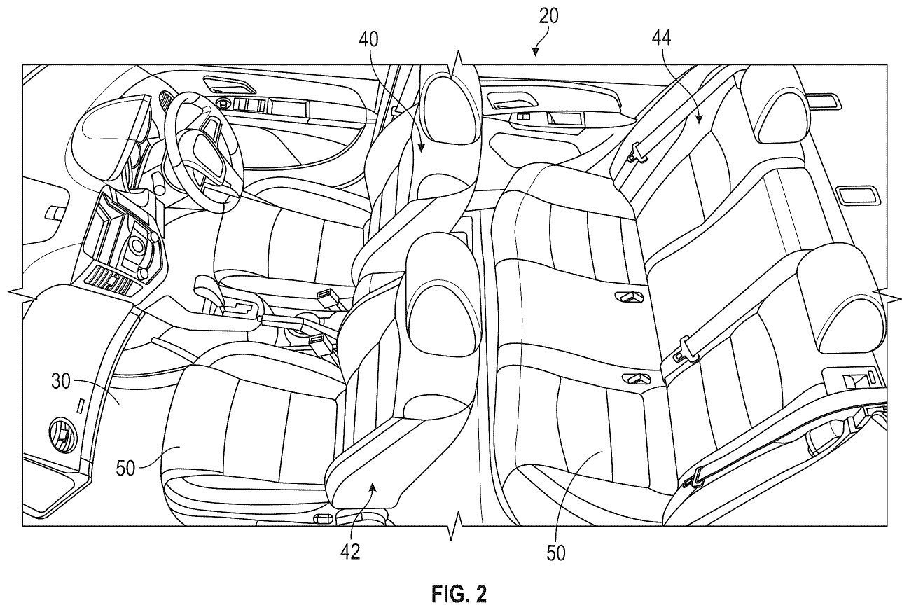

As shown in FIGS. 1 and 2, a vehicle 10 includes an interior cabin, shown as passenger cabin 20. In one embodiment, the vehicle 10 is configured as an on-road vehicle such as a sedan, a sport utility vehicle (“SUV”), a pickup truck, a van, and/or still another type of passenger vehicle. In other embodiments, the vehicle 10 is configured as another type of on-road vehicle such as a semi-truck, a bus, or the like. In still other embodiments, the vehicle 10 is configured as an off-road vehicle such as construction machinery, farming machinery, or the like.

As shown in FIG. 2, the passenger cabin 20 includes a support surface, shown as cabin floor 30, that supports one or more seating assemblies, shown as seats 40, including one or more first seating assemblies, shown as front seats 42, and one or more second seating assemblies, shown as rear seats 44. In some embodiments, the front seats 42 are different than the rear seats 44 (e.g., the front seats 42 recline while the rear seats 44 do not recline). In other embodiments, the front seats 42 and the rear seats 44 are the same or utilize similar components (e.g., to facilitate increased scaling for manufacturing and, therefore, a reduction in production costs). By way of example, the front seats 42 and the rear seats 44 may utilize the same or similar reclining mechanisms. By way of another example, the front seats 42 and the rear seats 44 may utilize a similar track assembly, however, the track assembly for one of the front seats 42 or the rear seats 44 may include one or more additional components (e.g., for added strength, to meet or exceed industry standards, etc.). In some embodiments, the passenger cabin 20 does not include the rear seats 44. In some embodiments, the passenger cabin 20 only includes a single front seat 42.

### Seat Assembly

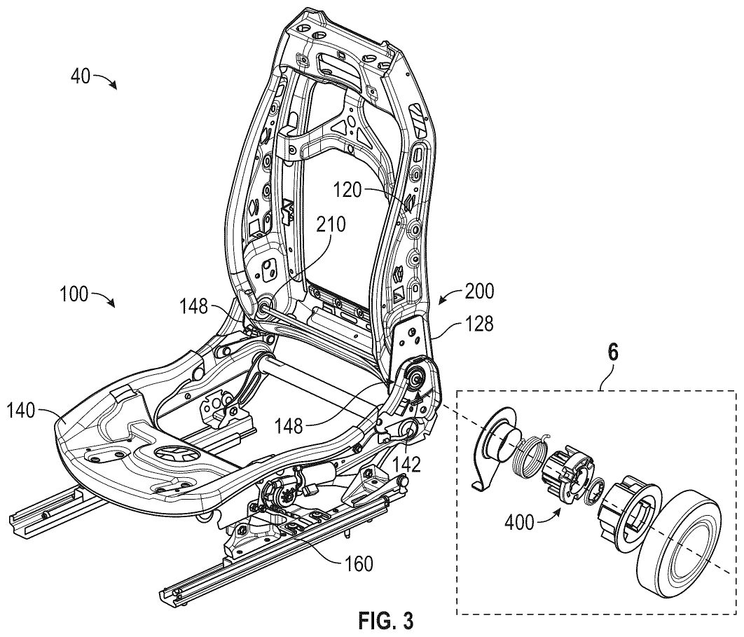

As shown in FIGS. 2 and 3, each of the seats 40 includes a plurality of padded components (e.g., a seat back pad or cushion, a seat bottom pad or cushion, etc.), shown as seat cushions 50, and a framing assembly, shown as frame assembly 100. As shown in FIG. 3, the frame assembly 100 includes (i) a first frame portion, shown as upper frame 120, configured to support an upper portion of the seat cushions 50, (ii) a second frame portion, shown as lower frame 140, configured to support a lower portion of the seat cushions 50, (iii) a rail portion, shown as track assembly 160, configured to support and couple to the lower frame 140 and, thereby, couple the seat 40 to the cabin floor 30, and (iv) a pivoting coupler or reclining mechanism, shown as recliner assembly 200, configured to couple the upper frame 120 to the lower frame 140 and facilitate pivoting of the upper frame 120 relative to the lower frame 140 (i.e., reclining the seat 40) between a first, upright position and one or more second, pivoted or reclined positions.

As shown in FIGS. 3, (i) the lower frame 140 includes first interfaces, shown as lower interfaces 148, positioned at opposing sides of the lower frame 140 that define first coupling apertures, shown as lower main attachment apertures 142, and (ii) the upper frame 120 includes second interfaces, shown as upper interfaces 128, positioned at opposing sides of the upper frame 120. According to an exemplary embodiment, the upper interfaces 128 of the upper frame 120 similarly define coupling apertures or upper main attachment apertures that align and interface with the lower main attachment apertures 142. As shown in FIG. 3, the width of the upper frame 120 is less than the width of the lower frame 140 such that the upper interfaces 128 of the upper frame 120 are received between the lower interfaces 148 of the lower frame 140. In other embodiments, the width of the upper frame 120 is greater than the width of the lower frame 140 such that the lower interfaces 148 of the lower frame 140 are received between the upper interfaces 128 of the upper frame 120.

### Recliner Assembly

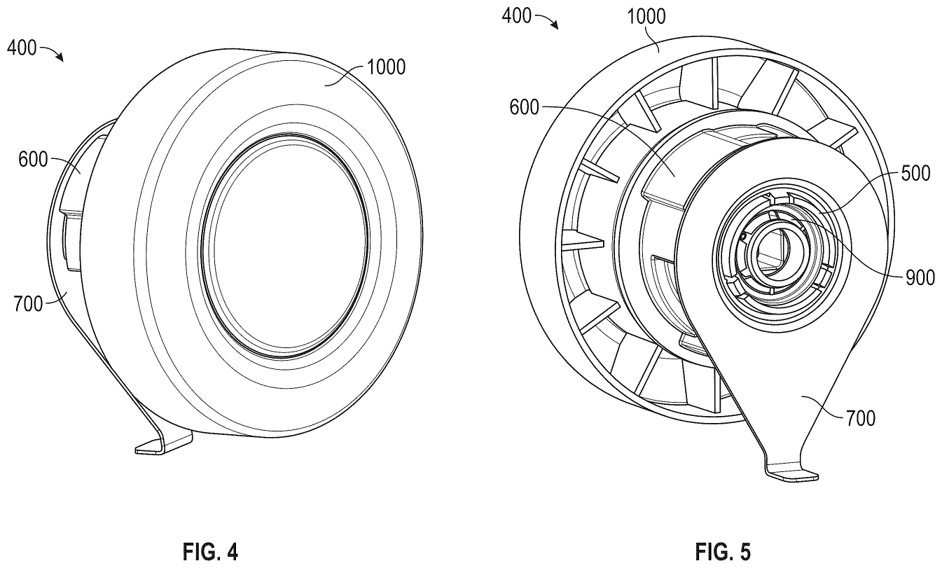

As shown in FIG. 3, the recliner assembly 200 includes a shaft, shown as connecting shaft 210, and a manual recliner mechanism, shown as manual recliner system 400, coupled to an end of the connecting shaft 210. The connecting shaft 210 extends between the lower interfaces 148 of the lower frame 140 and the upper interfaces 128 of the upper frame 120 to pivotably couple the lower frame 140 and the upper frame 120 together. As shown in FIGS. 4-7, the manual recliner system 400 includes an inner portion, shown as inner support 500, an outer portion, shown as outer housing 600, plate, shown as leaf-shaped plate 700, a biasing or resilient element (e.g., a torsion spring), shown as spring 800, a retainer, shown as retaining ring 900, and a cover, shown as end cap 1000. According to an exemplary embodiment, the inner support 500, the outer housing 600, the leaf-shaped plate 700, the spring 800, the retaining ring 900, and the end cap 1000 engage with each other and couple together to form the manual recliner system 400.

According to an exemplary embodiment, the end of the connecting shaft 210 is in engagement with a portion of inner support 500 (e.g., a through-hole defined therein) such that the connecting shaft 210 and the inner support 500 are rotatable together relative to rest of the manual recliner system 400. According to an exemplary embodiment, manual recliner system 400 is configured to (i) prevent the upper frame 120 from pivoting relative to the lower frame 140 when the when the manual recliner system 400 is not manually engaged by an occupant of the seat 40 engaged and (ii) permit the upper frame 120 to pivot relative to the lower frame 140 when the manual recliner system 400 is engaged by the occupant of the seat 40. Further details regarding the relationship and interactions between the various components of the manual recliner system 400 are provided in greater detail herein.

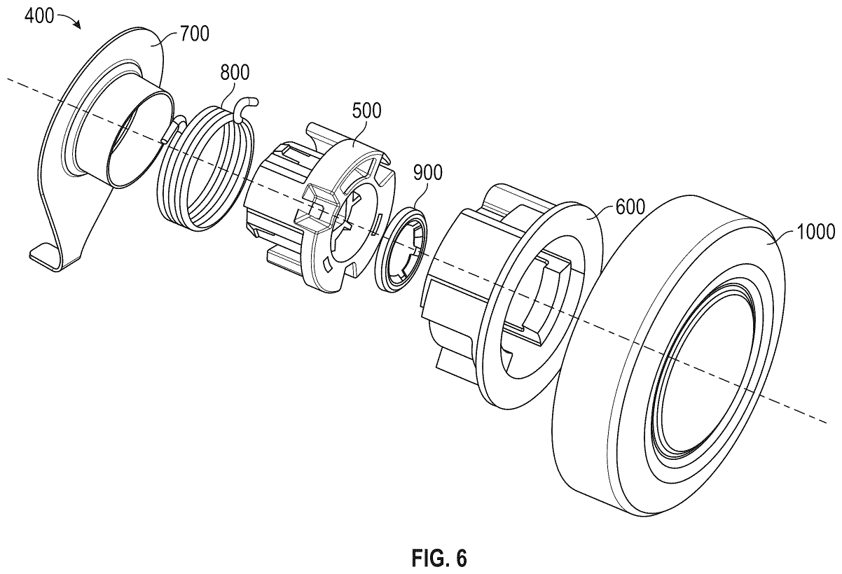

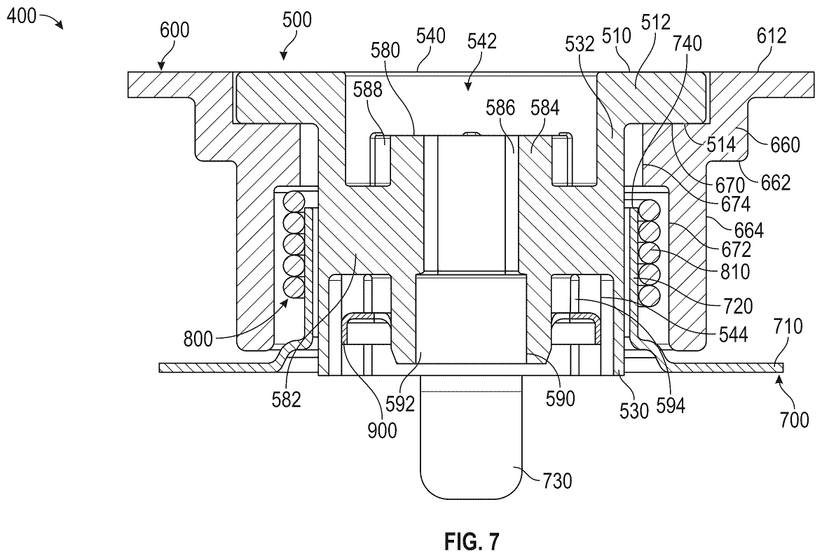

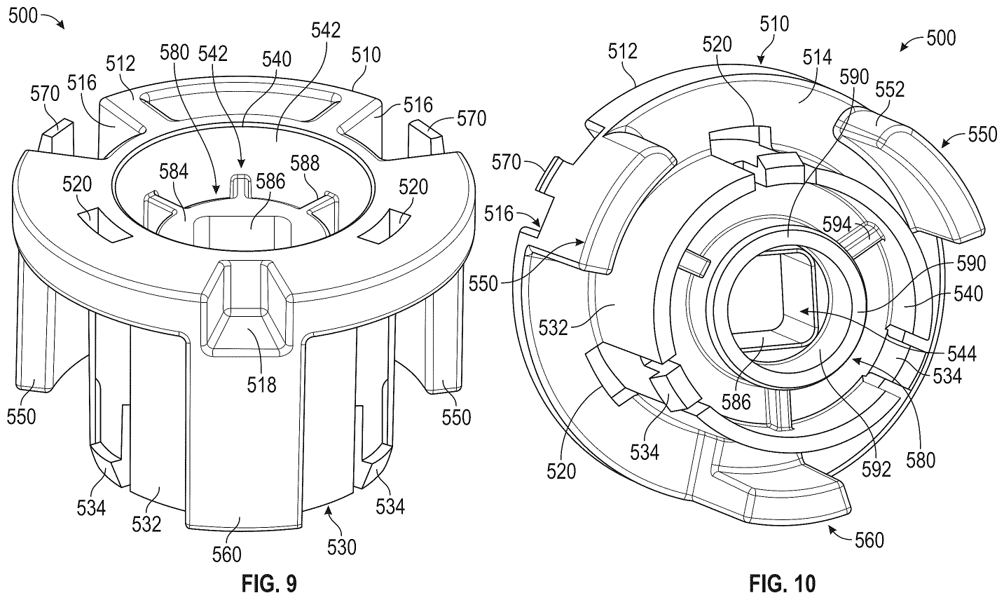

As shown in FIGS. 7, 9, and 10, the inner support 500 includes a base, shown as base ring 510, having a first surface, shown as outer surface 512, and an opposing second surface, shown as inner surface 514. As shown in FIGS. 9 and 10, the base ring 510 defines a plurality of first recesses, shown as notches 516, extending through the outer surface 512 and spaced along a peripheral edge of the base ring 510. As shown in FIG. 9, the base ring 510 defines a second recess, shown as notch 518, extending through the outer surface 512 and on the peripheral edge of the base ring 510. The notch 518 is positioned along an opposing side of the base ring 510 relative to the notches 516. As shown in FIGS. 9 and 10, the base ring 510 defines a plurality of apertures, shown as apertures 520, that extend through the base ring 510. The apertures 520 are positioned between the notches 516 and the notch 518. As shown in FIGS. 7, 9, and 10, a protrusion, shown as central protrusion 530, extends from the inner surface 514 of the base ring 510. The central protrusion 530 includes a plurality of surfaces, shown as outer walls 532, with a plurality of exterior facing clips or retainers, shown as clips 534, disposed between adjacent pairs of the outer walls 532. The clips 534 are aligned with the apertures 520 of the base ring 510. As shown in FIG. 9, the base ring 510 and the central protrusion 530 cooperatively define a cavity or bore, shown as inner cavity 540, extending through the inner support 500.

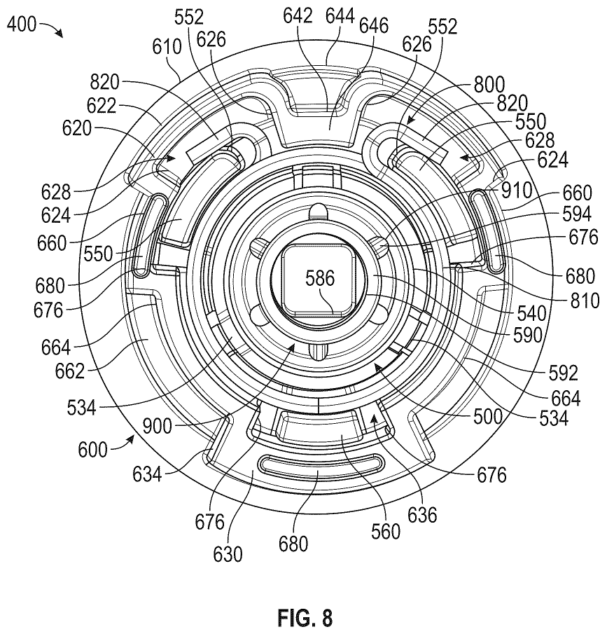

As shown in FIGS. 7-10, the base ring 510 includes a plurality of first protrusions, shown as first spring engagement features 550, extending from the inner surface 514. The first spring engagement features 550 are spaced radially outward relative to the central protrusion 530, are positioned at various locations along the peripheral edge of the inner surface 514 and extend parallel with the outer walls 532 of the central protrusion 530. In some embodiments, the first spring engagement features 550 are shorter in length than the length of the central protrusion 530. As shown in FIGS. 8 and 10, each of the first spring engagement features 550 has an engagement surface, shown as interior edge 552, that is configured to engage with a portion of the spring 800 (e.g., a leg thereof), as described in greater detail herein.

As shown in FIGS. 8-10, the base ring 510 includes a second protrusion, shown as second spring engagement feature 560, extending from the inner surface 514. The second spring engagement feature 560 is spaced radially outward relative to the central protrusion 530, is positioned along the peripheral edge of the inner surface 514, and extends parallel with the outer walls 532 of the central protrusion 530. In some embodiments, the second spring engagement feature 560 is shorter in length than the length of the central protrusion 530. The second spring engagement feature 560 extends from an opposite end of the base ring 510 relative to the first spring engagement features 550. As described in more detail herein, the first spring engagement features 550 and the second spring engagement feature 560 are configured to be spaced around an exterior of the spring 800.

As shown in FIGS. 9 and 10, the base ring 510 includes a plurality of retainers, shown as support tabs 570, extending from the first spring engagement features 550 into the notches 516 towards the outer surface 512 of the base ring 510. According to an exemplary embodiment, the support tabs 570 are configured to engage with portions of the outer housing 600 to couple the two components together.

As shown in FIGS. 7, 9, and 10, the inner cavity 540 of the inner support 500 is divided by an internal wall, shown as divider 580, into a first or outer portion, shown as outer chamber 542, and a second or inner portion, shown as inner chamber 544. The divider 580 has (i) a first protrusion, shown as outer protrusion 584, that extends from the divider 580 into the outer chamber 542 toward the base ring 510 and (ii) a second protrusion, shown as inner protrusion 590, that extends from the divider 580 into the inner chamber 544 away the base ring 510. As shown in FIGS. 7-10, the outer protrusion 584 defines a first passage, shown as outer aperture 586. According to an exemplary embodiment, the outer aperture 586 is configured to receive the end of the connecting shaft 210 to couple the inner support 500 to the connecting shaft 210. According to an exemplary embodiment, the outer aperture 586 and the end of the connecting shaft 210 have complimentary shapes such that the two components engage and rotate together. As shown in FIGS. 7-10, the outer aperture 586 has a square shape. In other embodiments, the outer aperture 586 has another shape (e.g., to correspond with another shape of the end of the connecting shaft 210, a star shape, an octagon shape, etc.). As shown in FIGS. 7, 8, and 10, the inner protrusion 590 defines a second passage, shown as inner aperture 592, that aligns with the outer aperture 586 to cooperatively define a passage through the divider 580 for the end of the connecting shaft 210 to extend. The inner aperture 592 has a second shape (e.g., a circular shape) that is different than a second shape (e.g., a square shape) of the outer aperture 586. As shown in FIG. 7, the inner aperture 592 has a larger diameter or width than a diameter or width of the outer aperture 586 such as a shoulder is defined therebetween.

As shown in FIGS. 7 and 9, the divider 580 has a plurality of first supports, shown as outer ribs 588, extending between an inner surface of the outer chamber 542 and an outer surface of the outer protrusion 584. As shown in FIGS. 7, 8, and 10, the divider 580 has a plurality of second supports, shown as inner ribs 594, extending between an inner surface of the inner chamber 544 and an outer surface of the inner protrusion 590.

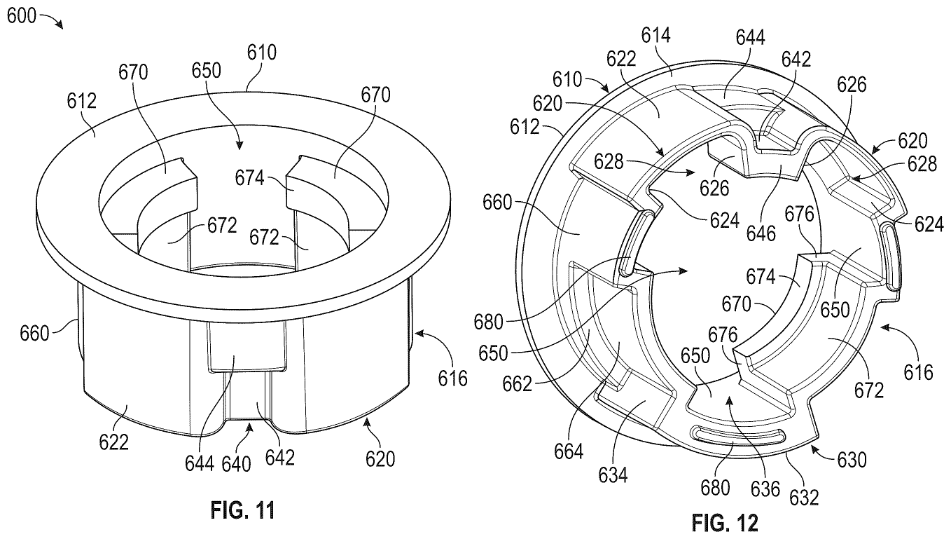

As shown in FIGS. 7, 11, and 12, the outer housing 600 includes a base, shown as base ring 610, having a first surface, shown as outer face 612, and an opposing second surface, shown as inner face 614. A protrusion, shown as central protrusion 616, extends from the inner face 614 of the base ring 610 and is configured to surround the inner support 500 and the spring 800. The central protrusion 616 includes or is formed by a plurality of features, components, protrusions, etc. As shown in FIGS. 11 and 12, the base ring 610 and the central protrusion 616 cooperatively define a central passage, shown as housing cavity 650, configured to receive various components of the manual recliner system 400 or portions thereof, as described in greater detail herein. As shown in FIGS. 8, 11, and 12, the central protrusion 616 includes a plurality of first protrusions, shown as spring protrusions 620. Each of the spring protrusions 620 has a first wall, shown as outer wall 622, a first inner wall, shown as inner wall 624, extending inward from a first end of the outer wall 622, and a second inner wall, shown as inner wall 626, extending inward from an opposing second end of the outer wall 622. According to an exemplary embodiment, the outer wall 622 has a curved shape or profile, the inner wall 624 has a straight shape or profile and the inner wall 626 has a curved shape or profile. As shown in FIGS. 8 and 12, the outer wall 622, the inner wall 624, and the inner wall 626 of each of the spring protrusions 620 define a cavity, shown as spring cavity 628, configured to accommodate a portion of the spring 800 (e.g., a leg thereof) and one of the first spring engagement features 550.

As shown in FIGS. 8 and 12, the central protrusion 616 includes a second protrusion, shown as inner support protrusion 630, positioned at an opposing end of the central protrusion 616 relative to the spring protrusions 620. The inner support protrusion 630 has a first wall, shown as outer wall 632, and opposing inner end walls, shown as inner walls 634, extending inward from opposing ends of the outer wall 632. According to an exemplary embodiment, the outer wall 632 has a curved shape or profile and the inner walls 634 have a straight shape or profile. As shown in FIGS. 8 and 12, the outer wall 632 and the inner walls 634 of the inner support protrusion 630 define a cavity, shown as inner support cavity 636, configured to accommodate the second spring engagement feature 560.

As shown in FIGS. 8, 11, and 12, the center protrusion includes a central connector or wall, shown as central notch 640, extending between the inner walls 626 and the outer walls 622 of the spring protrusions 620. The central notch 640 has a stepped profile formed by a first portion, shown as notched portion 642, and a second portion, shown as outer portion 644, where the notched portion 642 is recessed relative to the outer portion 644. As shown in FIGS. 8 and 12, notched portion 642 extends towards a center of the housing cavity 650 to provide a spring engagement feature, shown as central spring engagement features 646, positioned between the spring cavities 628 of the spring protrusions 620 that at least partially defines the inner walls 626 that is configured to engage with portion of the spring 800 (e.g., the legs thereof), as described in greater detail herein. The central spring engagement features 646 has a depth that extends to a portion of the spring 800 (e.g., a coil body thereof) and separates the spring cavities 628 from each other.

As shown in FIGS. 8, 10, and 11, the central protrusion 616 includes a plurality of stepped walls extending between the inner walls 624 of the spring protrusions 620 and the inner walls 634 of the inner support protrusion 630 to enclose the housing cavity 650. Each of the plurality of stepped walls includes a first component wall portion, shown as first stepped wall portion 660, extending from the inner walls 624 of the spring protrusions 620 and a second component wall portion, shown as second stepped wall portion 664, extending from the first stepped wall portion 660 to the inner walls 634 of the inner support protrusion 630. The second stepped wall portions 664 are spaced inward relative to the first stepped wall portions 660 by a connecting surface, shown as connecting portion 662, which extends along the inner face 614. The first stepped wall portions 660 are spaced further radially inward toward the center of the housing cavity 650 than the outer walls 622 of the spring protrusions 620. The second stepped wall portions 664 are spaced further radially inward toward the center of the housing cavity 650 than the first stepped wall portions 660 and the outer wall 632 of the inner support protrusion 630.

As shown in FIGS. 7, 11, and 12, the second stepped wall portions 664 include flanged portions or retainers, shown as housing tabs 670, that extend further radially inward toward the center of the housing cavity 650 than first interior faces, shown as first internal faces 672, of the second stepped wall portions 664 such that second interior faces, shown as second internal faces 674, of the housing tabs 670 are offset inward relative to the first internal faces 672. As shown in FIGS. 8 and 12, the second stepped wall portions 664 and the housing tabs 670 have opposing faces, shown as side faces 676, extending substantially perpendicular to the first internal faces 672 and the second internal faces 674. According to an exemplary embodiment, the side faces 676 are configured to limit rotation of the inner support 500 relative to the outer housing 600. By way of example, (i) the side faces 676 proximate the first stepped wall portions 660 and the spring cavities 628 may provide or function as first retainers or bump stops for the first spring engagement features 550 and/or (ii) the side faces 676 proximate the inner support cavity 636 may provide or function as second retainers or bump stops for the second spring engagement feature 560. As shown in FIG. 10, the first stepped wall portions 660 defines or include features, shown as grooves 680, at the free ends thereof.

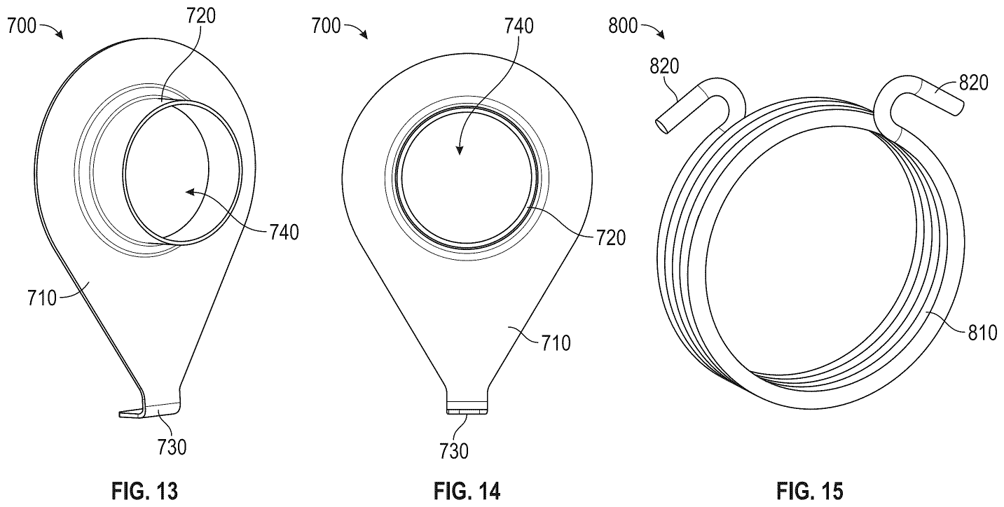

As shown in FIGS. 7, 13, and 14, the leaf-shaped plate 700 has (i) a base surface, shown as base plate 710, with a first protrusion, shown as arbor 720, extending outward from an upper end of the base plate 710 in a first direction from the base plate 710 and a second protrusion, shown as retainer 730, extending inward from a lower end of the base plate 710 in an opposing second first direction from the base plate 710. The arbor 720 defines a through-hole, shown as bore 740. According to an exemplary embodiment, the retainer 730 is configured to stabilize and rotationally fix the leaf-shaped plate relative to the frame assembly 100 of the seat 40 when coupled to the frame assembly 100.

As shown in FIG. 15, the spring 800 is configured as a torsion spring including a plurality of coils, shown as coiled body 810, with spring ends, shown as legs, extending radially outward from opposing ends of the coiled body 810. As described in more detail herein, the coiled body 810 is configured to be positioned along and around an exterior surface of the arbor 720 of the leaf-shaped plate 700 and the legs 820 are configured to selectively engage with the central notch 640 of the outer housing 600 and the first spring engagement features 550 of the inner support 500.

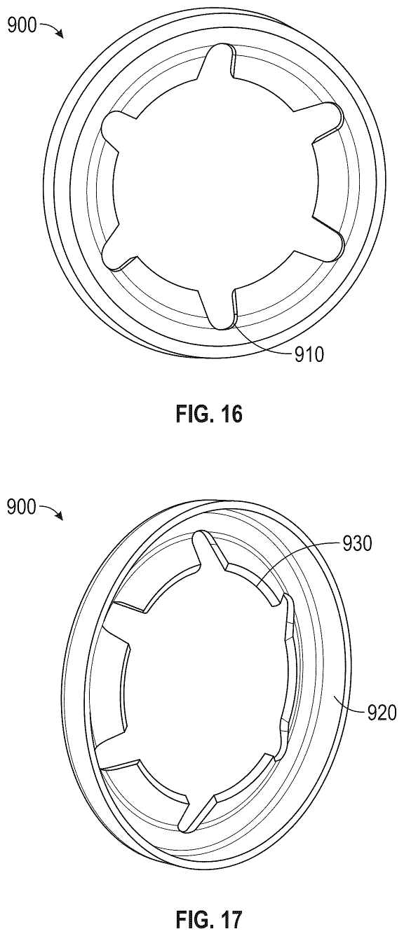

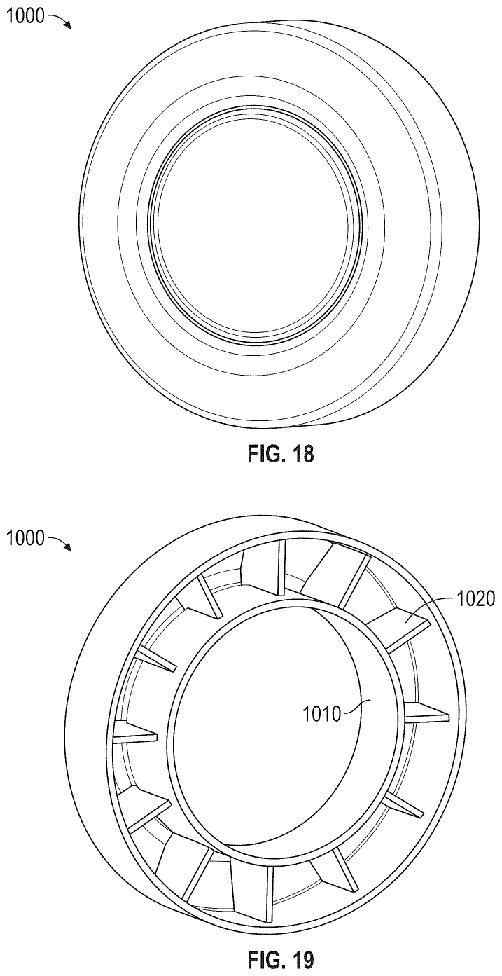

As shown in FIGS. 16 and 17, the retaining ring 900 includes a plurality of cutouts, shown as ridges 910, that extend radially inward from the center axis. As shown in FIG. 17, the retaining ring 900 includes an outer lip, shown as lip 920, extending along an outer periphery of the retaining ring 900. The retaining ring 900 includes a plurality of surfaces, shown as slanted flanges 930, positioned between the ridges 910 that extend inwards towards the center axis of the retaining ring 900. The slanted flanges 930 and the ridges 910 cooperatively define a central aperture of the retaining ring 900.

As shown in FIG. 19, the end cap 1000 defines an inner circular cavity, shown as cavity 1010, that is configured to enclose and/or engage with one or more components of the manual recliner system 400 (e.g., the outer housing 600). The end cap 1000 includes a plurality of connecting flanges, shown as flanges 1020, that connect the wall of the cavity 1010 to the outer edge of the end cap 1000. In some embodiments, the end cap 1000 is configured to function as an external knob that can be manually manipulated (e.g., rotated) by an operator to permit pivoting the upper frame 120 relative to the lower frame 140. In some embodiments, the external knob may take the form of a handle, a lever, or button.

As shown in FIGS. 7 and 8, the inner support 500, the outer housing 600, the leaf-shaped plate 700, the spring 800, the retaining ring 900, and the end cap 1000 engage with each other and couple together to form the manual recliner system 400. As shown in FIG. 7, the inner support 500 is positioned within the housing cavity 650 of the outer housing 600. According to an exemplary embodiment, the inner support 500 and the outer housing 600 are configured to pivot relative to one another about a central axis of the manual recliner system 400. As shown in FIG. 7, the inner surface 514 of the base ring 510 engages with the housing tabs 670 of the central protrusion 616 such that the outer surface 512 of the base ring 510 and the outer face 612 of the base ring 610 lie flush with one another to form a flat, level base of the manual recliner system 400. As shown in FIGS. 7 and 8, the outer walls 532 of the central protrusion 530 extend within and through the housing cavity 650 such that gaps are formed within the housing cavity 650 between the interior of the housing cavity 650 and the exterior of the central protrusion 530. As shown in FIG. 8, the first spring engagement features 550 are at least partially disposed within the spring cavities 628 of the spring protrusions 620 such that (i) the interior edges 552 of the first spring engagement features 550 extend past the inner walls 624 into the spring cavities 628 and (ii) the opposing edges of the first spring engagement features 550 are positioned proximate of the side faces 676 of the second stepped wall portions 664 of the central protrusion 616. Further, the second spring engagement feature 560 is disposed within the inner support cavity 636 of the inner support protrusion 630 between the side faces 676 of the second stepped wall portions 664 of the central protrusion 616.

As shown in FIGS. 7 and 8, the central protrusion 530 of the inner support 500 extends through the bore 740 of the arbor 720 of the leaf-shaped plate 700, while the first spring engagement features 550 and the second spring engagement feature 560 extend along the exterior surface of the arbor 720 with gaps positioned therebetween. In some embodiments, the support tabs 570 of the inner support 500 are configured to engage with the outer housing 600 (e.g., detents defined within an interior wall of housing cavity 650, an inner lip around the base ring 610, etc.) to secure (e.g., with a snap-fit connection) the inner support 500 with the outer housing 600. In some embodiments, the clips 534 of the central protrusion 530 are configured to engage with the rear side of the arbor 720 to secure (e.g., with a snap-fit connection) the inner support 500, and thereby the outer housing 600, to the leaf-shaped plate 700.

As shown in FIG. 7, the central protrusion 616 of the outer housing 600 is positioned around the central protrusion 530 of the inner housing and the arbor 720 of the leaf-shaped plate 700. As shown in FIGS. 7 and 8, The coiled body 810 is positioned along the exterior surface of the arbor 720 within the various gaps formed between (i) inner surfaces of the first spring engagement features 550 and the second spring engagement feature 560, (ii) the exterior surface of the arbor 720, and (iii) inner surfaces of the central protrusion 616 of the outer housing 600 and (iv) the exterior surface of arbor 720. According, the inner support 500, the outer housing 600, and the spring 800 engage with the leaf-shaped plate 700 and/or are positioned on the same side of the leaf-shaped plate 700. As shown in FIG. 8, the legs 820 of the spring 800 are disposed within the spring cavities 628 of the spring protrusions such that the central notch 640 is positioned between the legs 820 and the legs 820 at least partially curve around the interior edges 552 of the first spring engagement features 550. Therefore, the first spring engagement features 550 are positioned between the side faces 676 and the legs 820.

As shown in FIG. 7, the retaining ring 900 is positioned within the inner chamber 544 of the central protrusion 530 of the inner support 500 and is disposed around the inner protrusion 590 such that the ridges 910 and slanted flanges 930 engage with the inner ribs 594 and/or the inner protrusion 590, respectively.

According to an exemplary embodiment, the inner support 500, the outer housing 600, the spring 800, and retaining ring 900 interface with each other, the leaf-shaped plate 700, and the connecting shaft 210 such that the manual recliner system 400 (i) permits rotation of the upper frame 120 relative to the lower frame 140 when an external operator input is applied to the end cap 1000 or other knob/interface and (ii) prevents rotation of the upper frame 120 relative to the lower frame 140 when the external operator input is not applied to the end cap 1000 or other knob/interface.

According to an exemplary embodiment, when an operator interacts with the end cap 1000 or other knob/interface to engage the manual recliner system 400, the outer housing 600 will rotate and the central notch 640 will engage with one of the legs 820 of the spring 800 (e.g., depending on the direction at which the operator turns the end cap 1000). The engagement between the central notch 640 and one of the legs 820 causes the coiled body 810 to expand such that the spring force applied to the arbor 720 reduces and, therefore, permits rotation of the manual recliner system 400 (e.g., the outer housing 600, the inner support 500, the spring 800) and, thereby, rotation of the connecting shaft 210 and pivoting of the upper frame 120 relative to the lower frame 140.

Conversely, when a force is applied to the seat back from the operator without engagement of the end cap 1000 or other knob/interface, the connecting shaft 210 will begin to rotate, which causes the inner support 500 to rotate therewith such that (i) one of the first spring engagement features 550 rotates further into one of the spring cavities 628 until engagement with one of the legs 820 of the spring 800 and (ii) the other one of the first spring engagement features 550 rotates away from the other one of the spring cavities 628 until engagement with one of the side faces 676 of the central protrusion 616. The engagement between the first spring engagement features 550 and the legs 820 causes the inner support 500 to compress, and otherwise tighten, the spring 800 such that the spring force applied to the arbor 720 increases, jamming the manual recliner system 400, thereby, preventing rotation of the connecting shaft 210 and the upper frame 120 of the seat 40.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A manual recliner system for a vehicle seat, the manual recliner system comprising:
a plate having a protrusion extending therefrom, the protrusion defining a bore;
a spring including a coil body and a pair of legs, the coil body positioned along and around an exterior surface of the protrusion of the plate;
an inner support at least partially positioned within the bore, the inner support including a pair of protrusions extending outside of the bore and along an exterior of the coil body, each of the pair of protrusions configured to selectively engage with a respective one of the pair of legs of the spring; and
an outer housing disposed around the pair of protrusions of the inner support and the spring, the outer housing defining a pair of cavities with a notch positioned therebetween, the pair of cavities extending around the pair of legs, the notch configured to selectively engage with the pair of legs of the spring;
wherein the inner support and the outer housing engage with the plate on the same side of the plate.

2. The manual recliner system of claim 1, wherein the inner support includes a base and a central protrusion extending from the base.

3. The manual recliner system of claim 2, wherein the central protrusion includes a plurality of retainers spaced around a periphery thereof, and wherein the plurality of retainers are configured to engage with the plate.

4. The manual recliner system of claim 2, wherein the base defines a plurality of recesses positioned along a peripheral edge thereof, wherein the inner support includes a plurality of retainers that extend within the plurality of recesses, and wherein the plurality of retainers are configured to engage with the outer housing.

5. The manual recliner system of claim 2, wherein the base and the central protrusion cooperatively define an inner cavity, wherein the inner support includes a divider positioned within the inner cavity and separating the inner cavity into a first cavity portion and a second cavity portion, wherein the divider includes a first divider protrusion extending into the first cavity portion and defining a first aperture, wherein the divider includes a second divider protrusion extending into the second cavity portion and defining a second aperture aligned with the first aperture, the first aperture and the second aperture configured to receive a shaft of the vehicle seat.

6. The manual recliner system of claim 5, wherein the first aperture and the second aperture have different shapes.

7. The manual recliner system of claim 1, wherein the pair of cavities are first cavities and the pair of protrusions are first protrusions, wherein the outer housing defines a second cavity, and wherein the inner support includes a second protrusion extending outside of the bore, along the exterior of the coil body, and into the second cavity.

8. The manual recliner system of claim 1, wherein the outer housing includes a base and a central protrusion extending from the base, wherein the base and the central protrusion and cooperatively define cooperatively define an inner cavity within which the bore, the spring, and the inner support are disposed, and wherein the central protrusion defines the pair of cavities and the notch.

9. The manual recliner system of claim 8, wherein the central protrusion defines a pair of retainers, wherein the pair of cavities and the notch are positioned between the pair of retainers, and wherein each of the pair of protrusions is configured to selectively engage with a respective one of pair of retainers.

10. The manual recliner system of claim 1, wherein engagement between the notch and one of the pair of legs causes the outer housing to expand the coil body such that a spring force applied to the protrusion by the spring reduces and permits reclining the vehicle seat.

11. The manual recliner system of claim 10, further comprising a knob, wherein the notch engages with the one of the pair of legs when an operator interacts with the knob.

12. The manual recliner system of claim 1, wherein engagement between one of the pair of protrusions and one of the pair of legs causes the inner support to compress the coil body such that a spring force applied by the spring to the protrusion increases and prevents reclining the vehicle seat.

13. The manual recliner system of claim 12, wherein the one of the pair of protrusions engage with the one of the pair of legs when a force is applied to a seat back of the vehicle seat from an operator without manually engaging with the manual recliner system.

14. The manual recliner system of claim 1, wherein the plate includes a retainer extending from an end thereof opposite the protrusion and in an opposing direction relative to the protrusion, and wherein the retainer is configured to engage with the vehicle seat to rotationally fix the plate relative to the vehicle seat.

15. A seat comprising:
a frame assembly including a seat bottom and a seat back; and
a recliner assembly configured to facilitate pivoting of the seat back relative to the seat bottom, the recliner assembly including:
a connecting shaft extending between the seat bottom and the seat back; and
a manual reclining system including:
a plate having a protrusion extending therefrom, the protrusion defining a bore;
a spring including a coil body and a pair of legs, the coil body positioned along and around an exterior surface of the protrusion of the plate;
an inner support at least partially positioned within the bore, the inner support including a pair of protrusions extending outside of the bore and along an exterior of the coil body, each of the pair of protrusions configured to selectively engage with a respective one of the pair of legs of the spring; and
an outer housing disposed around the protrusion of the inner support and the spring, the outer housing defining a pair of cavities with a notch positioned therebetween, the pair of cavities extending around the pair of legs, the notch configured to selectively engage with the pair of legs of the spring.

16. The seat of claim 15, wherein the inner support and the outer housing engage with the plate on the same side of the plate.

17. The seat of claim 15, wherein engagement between the notch and one of the pair of legs causes the outer housing to expand the coil body such that a spring force applied to the protrusion by the spring reduces and permits reclining the seat.

18. The seat of claim 15, wherein engagement between one of the pair of protrusions and one of the pair of legs causes the inner support to compress the coil body such that a spring force applied by the spring to the protrusion increases and prevents reclining the seat.

19. A manual recliner system for a vehicle seat, the manual recliner system comprising:
a plate having a protrusion extending therefrom, the protrusion defining a bore;
a spring including a coil body and a pair of legs, the coil body positioned along and around an exterior surface of the protrusion of the plate;
an inner support including (i) a central protrusion at least partially positioned within the bore and (ii) a pair of protrusions radially spaced from the central protrusion and extending outside of the bore and along an exterior of the coil body, each of the pair of protrusions configured to selectively engage with a respective one of the pair of legs of the spring; and
an outer housing disposed around the pair of protrusions of the inner support and the spring, the outer housing defining a pair of cavities with a notch positioned therebetween, the pair of cavities extending around the pair of legs, the notch configured to selectively engage with the pair of legs of the spring.

20. The manual recliner system of claim 19, wherein the inner support and the outer housing engage with the plate on the same side of the plate.
